(19) United States
(12) Patent Application Publication
(10) Pub. No.: US 2025/0146882 A1
(43) Pub. Date: May 8, 2025

(54) TEMPERATURE SENSOR

(71) Applicant: SHIBAURA ELECTRONICS CO., LTD., Saitama-shi, Saitama (JP)

(72) Inventors: Takamasa Yoshihara, Saitama-shi, Saitama (JP); Kouhei Saito, Semboku City Akita (JP)

(21) Appl. No.: 18/041,183

(22) PCT Filed: Sep. 9, 2021
(86) PCT No.: PCT/JP2021/033171

§ 371 Date: Jan. 22, 2025

(51) Int. Cl. G01K 1/14; G01K 1/08; G01K 7/22

(52) U.S. Cl. CPC G01K 1/14; G01K 1/08; G01K 7/22

(57) ABSTRACT

An object is to provide a temperature sensor that requires reduced working manhours to fix the temperature sensor to a temperature measurement object. To achieve the object, the temperature sensor includes: a thermosensitive body; a pair of electric wires electrically connected to the thermosensitive body; a protector made of a resin and covering the thermosensitive body and a part of the pair of electric wires; and a fixing element for a temperature measurement object, which is provided integrally with the protector.

This is the National Stage of PCT international application PCT/JP2021/033171 filed on Sep. 9, 2021, the content of which is incorporated herein by reference in its entirety.

### TECHNICAL FIELD

The present invention relates to a temperature sensor easily fixed to a temperature measurement object.

### BACKGROUND ART

For example, a temperature sensor that includes a thermosensitive body composed of a thermistor, extension wires electrically connected to the thermosensitive body, and lead wires electrically connected to the extension wires has been widely used. The thermosensitive body is covered with a covering layer made of an electric insulation material such as glass in some cases.

The temperature sensor is preferably in proximity to a temperature measurement object in order to obtain accuracy of a measured temperature. As a typical example in which the temperature sensor is in proximity to the temperature measurement object, the temperature sensor is fixed to the temperature measurement object.

For example, a temperature sensor disclosed in Patent Literature 1 includes a metal case housing a thermosensitive body and a glass protective layer, and the case includes a lug terminal including a heat transfer surface for the temperature measurement object. According to the temperature sensor disclosed in Patent Literature 1, it is possible to bring the heat transfer surface into tight contact with the temperature measurement object by screwing the lug terminal to the temperature measurement object.

### CITATION LIST

### Patent Literature

Patent Literature 1: JP 6371002 B2

### SUMMARY OF INVENTION

### Technical Problem

In the temperature sensor disclosed in Patent Literature 1, it is possible to bring the heat transfer surface of the lug terminal into tight contact with the temperature measurement object. Therefore, accuracy of the measured temperature can be secured. In Patent Literature 1, however, the temperature sensor includes the metal case including the lug terminal, and a work of housing a main body portion of the temperature sensor in the case is necessary. Accordingly, manhours for works including a work of fixing the lug terminal to the temperature measurement object with a fastening tool are increased.

Accordingly, an object of the present invention is to provide a temperature sensor that requires reduced working manhours to fix the temperature sensor to a temperature measurement object.

### Solution to Problem

A temperature sensor according to the present invention includes: a thermosensitive body; a pair of electric wires electrically connected to the thermosensitive body; a protector made of a resin and covering the thermosensitive body and a part of the pair of electric wires; and a fixing element provided integrally with the protector and used for fixation to a temperature measurement object.

The fixing element according to the present invention is preferably provided in a free region off a sensor element retention area of the protector where the thermosensitive body and the electric wires are provided.

The free region according to the present invention preferably has a dimension in a thickness direction set less than a dimension in the thickness direction of the sensor element retention area.

The fixing element is preferably a fixing hole penetrating through the protector from a front surface to a rear surface. In this case, the temperature sensor is preferably fixed to the temperature measurement object by a fastening tool inserted into the fixing hole.

Alternatively, the fixing element is preferably a fixing protrusion protruding from a surface of the protector. In this case, the temperature sensor is preferably fixed to the temperature measurement object with the fixing protrusion being inserted into a retention hole provided in the temperature measurement object.

### Advantageous Effects of Invention

In the temperature sensor according to the present invention, the fixing element used for fixation to the temperature measurement object is provided in the protector. The protector is provided to protect components of the temperature sensor such as the thermosensitive body, and the temperature sensor includes the fixing element integrated with the protector. Therefore, according to the temperature sensor in the present invention, a work of fabricating an individual member to provide the fixing element and attaching the member to the temperature sensor can be eliminated. This makes it possible to reduce the working manhours required to fix the temperature sensor to the temperature measurement object.

### BRIEF DESCRIPTION OF DRAWINGS

FIGS. 1A and 1B each illustrate a temperature sensor according to a first embodiment, FIG. 1A being a plan view, and FIG. 1B being a bottom view.

FIGS. 2A and 2B each illustrate the temperature sensor according to the first embodiment, FIG. 2A being a left side view, and FIG. 2B being a right side view.

FIGS. 3A and 3B are diagrams, each illustrating a procedure of fixing the temperature sensor according to the first embodiment to a temperature measurement object.

FIGS. 4A and 4B are diagrams, each illustrating a modification of the temperature sensor according to the first embodiment.

FIGS. 5A and 5B are diagrams, each illustrating another modification of the temperature sensor according to the first embodiment.

FIGS. 6A and 6B are diagrams, each illustrating still another modification of the temperature sensor according to the first embodiment.

FIGS. 7A and 7B are diagrams, each illustrating still another modification of the temperature sensor according to the first embodiment.

FIGS. 8A and 8B each illustrate a temperature sensor according to a second embodiment, FIG. 8A being a plan view, and FIG. 8B being a bottom view.

FIGS. 9A and 9B each illustrate the temperature sensor according to the second embodiment, FIG. 9A being a left side view, and FIG. 9B being a right side view.

FIGS. 10A and 10B are diagrams, each illustrating a procedure of fixing the temperature sensor according to the second embodiment to the temperature measurement object.

FIGS. 11A, 11B, and 11C are diagrams, each illustrating another procedure of fixing the temperature sensor according to the second embodiment to the temperature measurement object.

### DESCRIPTION OF EMBODIMENTS

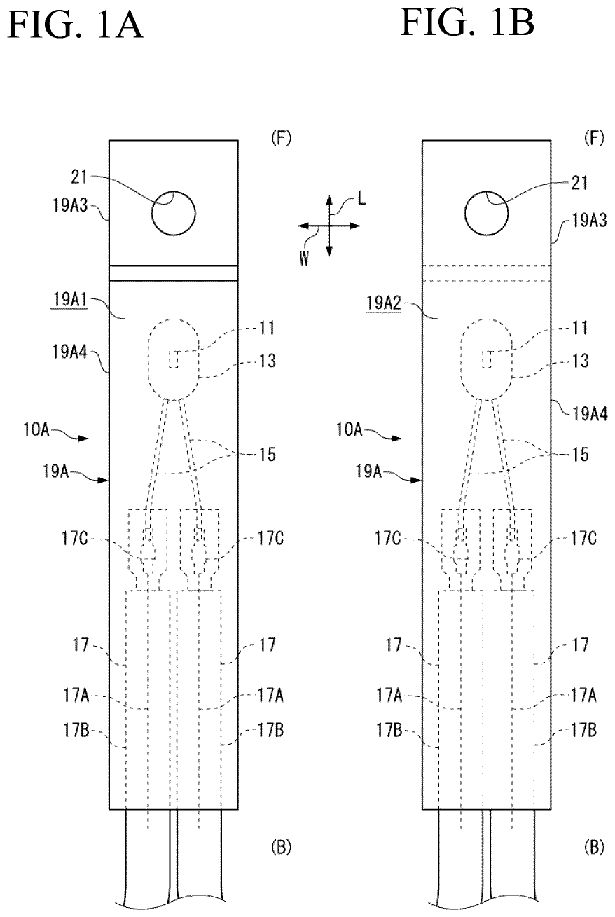

### [First Embodiment: FIGS. 1A, 1B to FIGS. 7A, 7B]

A temperature sensor 10A according to a first embodiment includes, as an example of a fixing element used for fixation to a temperature measurement object, a fixing hole 21 into which, for example, a fastening tool is inserted. The fixing hole 21 is provided in a protector 19 directly covering a thermosensitive body 11 of the temperature sensor 10A. The temperature sensor 10A is described below with reference to FIGS. 1A, 1B to FIGS. 7A, 7B.

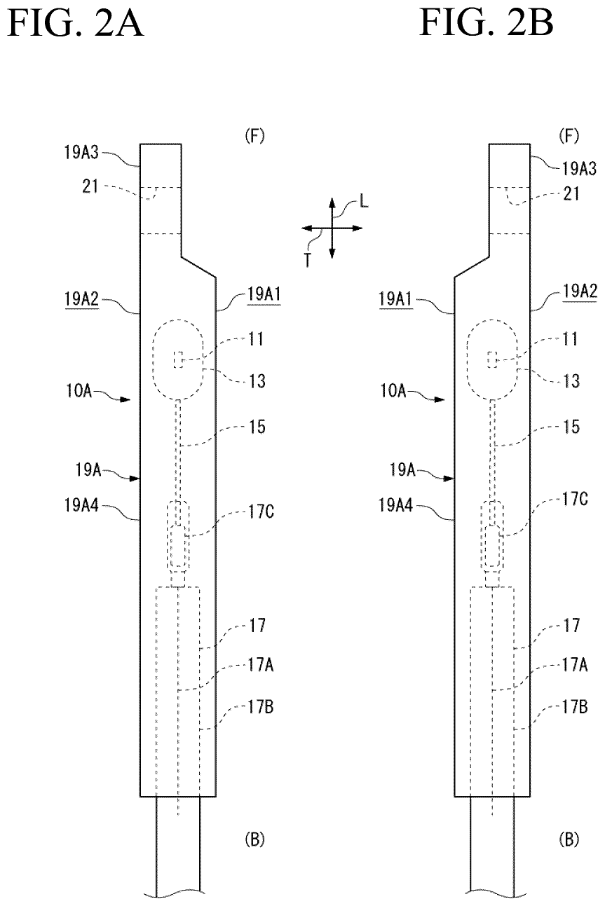

### [Temperature Sensor 10A: FIGS. 1A, 1B and FIGS. 2A, 2B]

As illustrated in FIGS. 1A, 1B and FIGS. 2A, 2B, the temperature sensor 10A includes the thermosensitive body 11, a glass protective layer 13 covering circumference of the thermosensitive body 11, a pair of extension wires 15 and 15 electrically connected to the thermosensitive body 11, and lead wires 17 and 17 respectively connected to the extension wires 15 and 15. The extension wires 15 and 15 and the lead wires 17 and 17 constitute a pair of electric wires according to the present invention. The temperature sensor 10A further includes a protector 19 that is made of a resin material and covers the whole of each of the thermosensitive body 11, the protective layer 13, and the extension wires 15 and 15, and front end parts of the lead wires 17 and 17. In the temperature sensor 10A, as illustrated in FIGS. 1A, 1B and FIGS. 2A, 2B, a side on which the thermosensitive body 11 is provided is defined as a front side (F), and a side opposite thereto is defined as a rear side (B). The definitions are relative to each other. Further, in the temperature sensor 10A, as illustrated in FIGS. 1A, 1B and FIGS. 2A, 2B, a longitudinal direction (L), a width direction (W), and a thickness direction (T) are defined. The definitions are used for convenience of description of the present embodiment, and do not particularly limit the present invention.

### [Thermosensitive Body 11]

For example, a thermistor (thermally sensitive resistor) is adopted as the thermosensitive body 11. The thermistor is a metal oxide that measures a temperature by using variation of an electric resistance with the temperature.

The thermistor is classified into an NTC (negative temperature coefficient) thermistor and a PTC (positive temperature coefficient) thermistor, and any of the thermistors is usable for the thermosensitive body 11.

As the NTC thermistor, an oxide sintered body that includes, as a basic composition, a manganese oxide (Mn₃O₄) having a spinel structure is usable for the thermosensitive body 11. The oxide sintered body that includes a composition of MₓMn₃₋ₓO₄ obtained by adding an M element (one or more types of Ni, Co, Fe, Cu, Al, and Cr) to the basic composition is usable for the thermosensitive body 11. Further, one or more types of V, B, Ba, Bi, Ca, La, Sb, Sr, Ti, and Zr can be added thereto.

As the PTC thermistor, an oxide sintered body that includes, as a basic composition, a composite oxide having a typical perovskite structure, for example, YCrO₃ is usable for the thermosensitive body 11.

An electric resistance element made of, for example, platinum other than the thermistor is also usable for the thermosensitive body 11.

### [Protective Layer 13: FIGS. 1A, 1B and FIGS. 2A, 2B]

The glass protective layer 13 suppresses chemical and mechanical change of the thermosensitive body 11 due to an environment condition and mechanically protects the thermosensitive body 11 by sealing and keeping the thermosensitive body 11 in an air-tight state. The glass protective layer 13 covers front ends of the extension wires 15 and 15 in addition to the whole of the thermosensitive body 11, and seals the extension wires 15 and 15.

Note that providing of the glass protective layer 13 is merely a preferred example, and providing of the protective layer 13 is optional in the present invention.

### [Extension Wires 15 and 15: FIGS. 1A, 1B and FIGS. 2A, 2B]

The extension wires 15 and 15 are electrically connected to a pair of unillustrated electrodes of the thermosensitive body 11.

Since the extension wires 15 and 15 are sealed by the protective layer 13, a Dumet wire that has a linear expansion coefficient similar to a linear expansion coefficient of the glass configuring the protective layer 13 is preferably used as each of the extension wires 15 and 15. Note that the Dumet wire is a conductive wire in which an alloy mainly containing iron and nickel is used as a conductor (core wire) and the conductor is covered with copper.

### [Lead Wires 17 and 17: FIGS. 1A, 1B and FIGS. 2A, 2B]

The lead wires 17 and 17 respectively includes core wires 17A and 17A each including a conductor, and electric insulation coverings 17B and 17B covering circumferences of the core wires 17A and 17A. At one end sides of the lead wires 17 and 17, the core wires 17A and 17A are exposed from the insulation coverings 17B within a predetermined range. Exposed parts of the core wires 17A and 17A are respectively electrically connected to the extension wires 15 and 15.

In the present embodiment, ends of the extension wires 15 are joined with pads 17C and 17C connected to the core wires 17A by welding or the like. As a result, the extension wires 15 and 15 and the core wires 17A and 17A are electrically connected. The other ends of the lead wires 17 and 17 are connected to an unillustrated circuit board through other electric wires as necessary.

### [Protector 19A: FIGS. 1A, 1B and FIGS. 2A, 2B]

The protector 19A covers the temperature sensor 10A over the thermosensitive body 11, the protective layer 13, the extension wires 15 and 15 drawn out from the thermosensitive body 11, and parts of the lead wires 17 and 17 connected to the extension wires 15 and 15. As such, the protector 19A is provided to protect elements of the temperature sensor 10A such as the thermosensitive body 11, from external factors.

The protector 19A protects the thermosensitive body 11, the extension wires 15 and 15, and the core wires 17A and 17A of the lead wires 17 and 17 from external force of impact and the like.

The protector 19A is preferably made of a fluorine resin such as polytetrafluoroethylene (PTFE) and a tetrafluoroethylene-perfluoroalkylvinylether copolymer (PFA). In addition to these resin materials, the protector 19A can be made of an appropriate resin material irrespective of a thermoplastic resin and a thermosetting resin.

In a case where the protector 19A is made of a transparent resin, it is possible to perform appearance inspection of the thermosensitive body 11 through the protector 19A.

As a preferred example, the protector 19A has a rectangular-parallelepiped appearance shape extending in the longitudinal direction (L); however, the protector 19A may have the other appearance shape such as a columnar shape. Further, the protector 19A can be manufactured by, for example, placing the temperature sensor 10A in a mold and performing injection molding.

The protector 19A includes, ahead of the thermosensitive body 11 (i.e., closer to the front side (F) than the thermosensitive body 11), the fixing hole 21 that penetrates through the protector 19A from a front surface 19A1 to a rear surface 19A2 in the thickness direction (T). The fixing hole 21 is an example of the fixing element according to the present invention. The fixing hole 21 illustrated in FIGS. 1A, 1B and FIGS. 2A, 2B has a circular opening shape. However, as specifically described below, the opening shape of the fixing hole 21 according to the present invention is not limited to the circular shape.

The fixing hole 21 is provided in a thin portion 19A3 provided in a front (F) portion of the protector 19A. The elements of the temperature sensor 10A such as the thermosensitive body 11 and extension wires 15 and 15 except for the protector 19A are not provided in the thin portion 19A3. Even when the thin portion 19A3 is fastened by a fastening tool, mechanical pressure is hardly applied to the elements of the temperature sensor 10A. The thin portion 19A3 has a thickness of, for example, about ½ of a thickness of a thick portion 19A4 except for the thin portion 19A3. The protector 19A including the fixing hole 21 is integrally formed by, for example, injection molding of the above-described resin material. In other words, preparation of an individual member and manhours to form the fixing hole 21 in the protector 19A are not required.

The thick portion 19A4 is regarded as a sensor element retention area where the elements of the temperature sensor 10A such as the thermosensitive body 11 and the extension wires 15 and 15 are retained. Further, the thin portion 19A3 is regarded as a free region off the sensor element retention area.

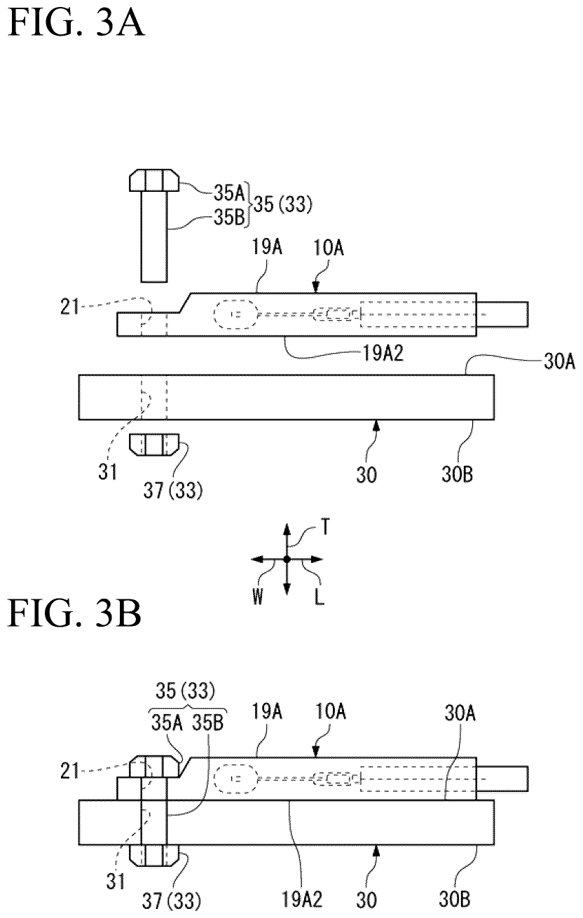

### [Procedure of Fixing Temperature Sensor 10A: FIGS. 3A, 3B]

Next, an example of a procedure of fixing the temperature sensor 10A to a temperature measurement object 30 is described with reference to FIGS. 3A, 3B. In the fixing procedure, the temperature sensor 10A is fixed to the temperature measurement object 30 by a fastening tool 33 including a bolt 35 and a nut 37.

First, as illustrated in FIG. 3A, the fixing hole 21 of the protector 19A and the fixing hole 21 provided in the temperature measurement object 30 are aligned. The alignment is performed in the longitudinal direction (L) and the width direction (W). Further, in this example, the bolt 35 is disposed toward the temperature sensor 10A, and the nut 37 is disposed toward the temperature measurement object 30. The bolt 35 is aligned with the fixing hole 21, and the nut 37 is aligned with the fixing hole 21.

After the protector 19A, the temperature measurement object 30, the bolt 35, and the nut 37 are aligned, a screw portion 35B of the bolt 35 is inserted into the fixing hole 21 and a retention hole 31 so as to penetrate through them, and a front end part of the screw portion 35B is exposed on a rear surface side (lower side in figure) of the temperature measurement object 30 as illustrated in FIG. 3B. After the nut 37 is fitted to the exposed front end part of the screw portion 35B, a head portion 35A of the bolt 35 is fastened while the nut 37 is held so as not to rotate.

By the above-described procedure, the temperature sensor 10A can be brought into tight contact with the temperature measurement object 30. As illustrated in FIG. 3B, a supporting surface 30A of the temperature measurement object 30 on which the temperature sensor 10A is placed is flat, and the rear surface 19A2 of the protector 19A serving as a heat sensing surface of the temperature sensor 10A is also flat. Therefore, the heat sensing surface of the temperature sensor 10A can be brought into tight contact with the supporting surface 30A of the temperature measurement object 30. However, the flat supporting surface 30A and the flat heat sensing surface (rear surface 19A2) are merely illustrative. In the present invention, in place of the flat surface, other forms such as a curved surface and an irregular surface are adoptable. Further, a form in which the protector 19A is made of a flexible material and deforms following the flat supporting surface 30A or the non-flat supporting surface 30A of the temperature measurement object 30 is also adoptable.

### [Effects by Temperature Sensor 10A]

In the temperature sensor 10A, the fixing hole 21 to fix the temperature sensor 10A to the temperature measurement object 30 by the fastening tool is provided in the protector 19A. The protector 19A is provided to protect the thermosensitive body 11 and the like, and the temperature sensor 10A includes the fixing hole 21 in the protector 19A. Therefore, according to the temperature sensor 10A, a work of fabricating an individual member to provide the fixing hole 21 as the fixing element and attaching the member to the temperature sensor 10A can be eliminated. This makes it possible to reduce the working manhours required to fix the temperature sensor 10A to the temperature measurement object 30.

Further, the fixing hole 21 in the temperature sensor 10A is provided in the thin portion 19A3 provided in the front (F) portion of the protector 19A. The elements of the temperature sensor 10A such as the thermosensitive body 11 and the extension wires 15 and 15 except for the protector 19A are not provided in the thin portion 19A3. Even when the thin portion 19A3 is fastened by the fastening tool, mechanical pressure is hardly applied to the elements of the temperature sensor 10A such as the thermosensitive body 11.

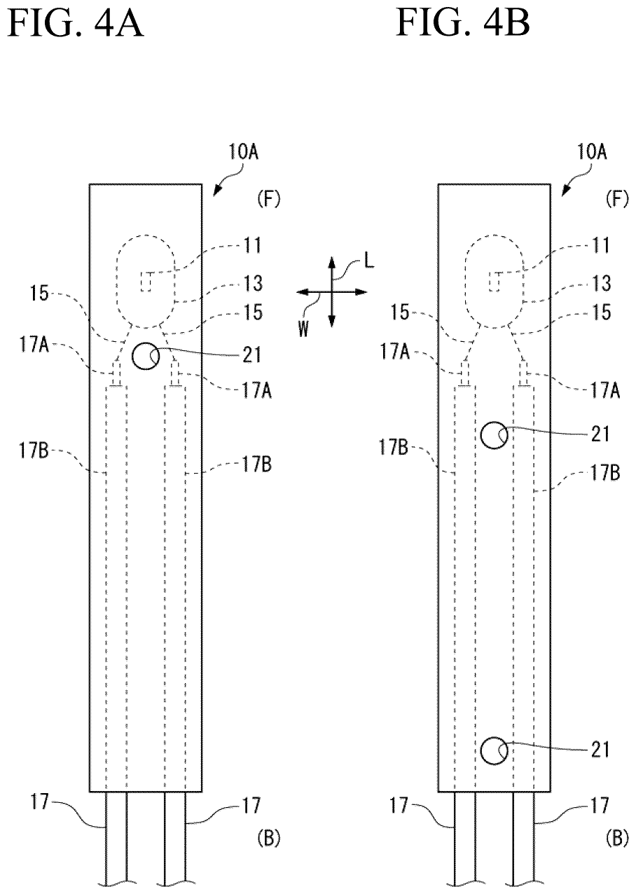

### [Modifications of First Embodiment: FIGS. 4A, 4B, FIGS. 5A, 5B, FIGS. 6A, 6B, and FIGS. 7A, 7B]

Next, modifications of the temperature sensor 10A according to the first embodiment are described with reference to FIGS. 4A, 4B to FIGS. 7A, 7B.

FIGS. 4A, 4B each illustrate a modification relating to a position where the fixing hole 21 is provided.

FIG. 4A illustrates an example in which the fixing hole 21 is provided posterior to the thermosensitive body 11 (i.e., closer to the rear side (B) than the thermosensitive body 11) and between the extension wires 15 and 15 and the core wires 17A and 17A of the lead wires 17 and 17. FIG. 4B illustrates an example in which the fixing holes 21 are provided posterior to the thermosensitive body 11 (i.e., closer to the rear side (B) than the thermosensitive body 11) and between the insulation coverings 17B and 17B of the lead wires 17 and 17. Note that FIG. 4B illustrates the example in which the two fixing holes 21 are provided; however, the number of fixing holes 21 may be one or three or more.

As described above, in the first embodiment, the working manhours required to fix the temperature sensor 10A to the temperature measurement object 30 can be reduced by providing the fixing hole 21 posterior to the thermosensitive body 11 (i.e., closer to the rear side (B) than the thermosensitive body 11) and between the extension wires 15 and 15, or between the lead wires 17 and 17, or both. Note that the specifications such as the position of the fixing hole 21 and a dimension of the fastening tool are preferably and appropriately set such that, when the fastening tool is inserted into the fixing hole 21 and is fastened, mechanical pressure is not applied to the thermosensitive body 11, the extension wires 15 and 15, and the lead wires 17 and 17.

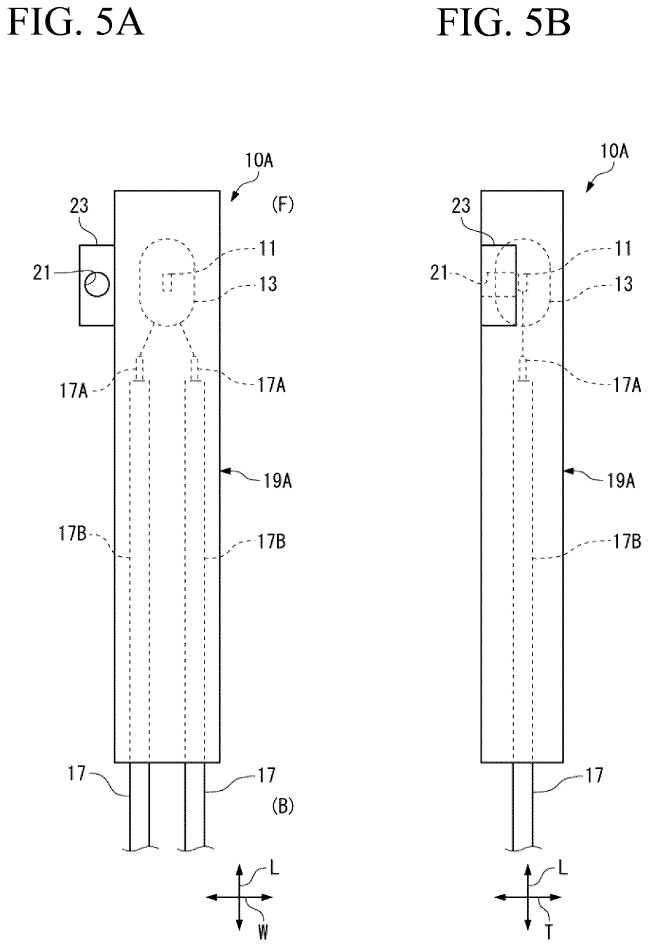

FIGS. 5A, 5B each illustrate a modification in which a fixing piece 23 is formed integrally with the protector 19A along one of sides in the width direction (W) of the protector 19A, and the fixing hole 21 is formed so as to penetrate through the fixing piece 23 in the thickness direction (T). The modifications illustrated in FIGS. 5A, 5B are adopted, for example, in a case where the fixing hole 21 cannot be provided in a range of the protector 19A in a planar view because of relationship with the temperature measurement object 30.

The fixing piece 23 can be provided integrally with the protector 19A by injection molding. Therefore, even in the modifications illustrated in FIGS. 5A, 5B, the working manhours required to fix the temperature sensor 10A to the temperature measurement object 30 can be reduced.

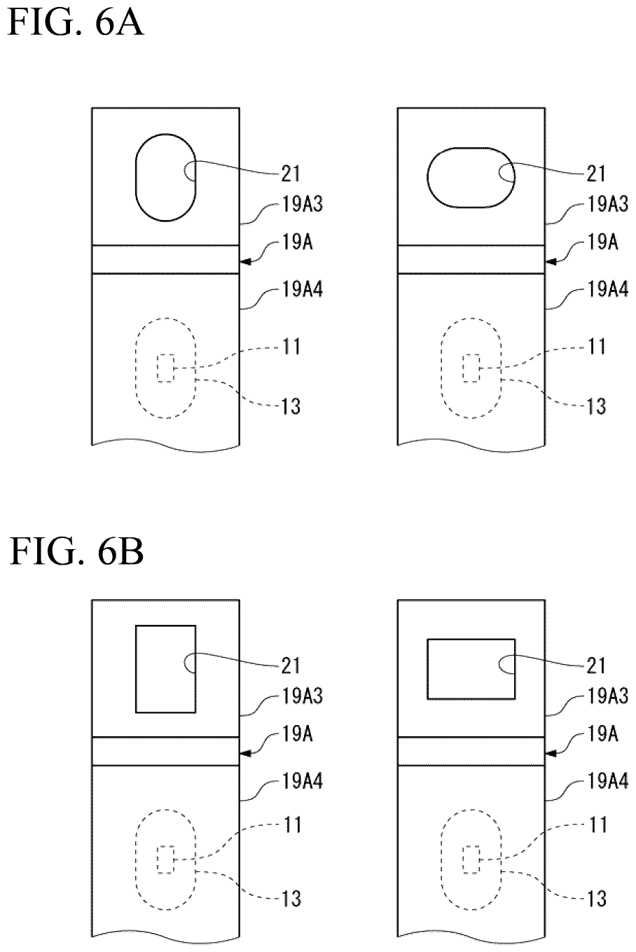

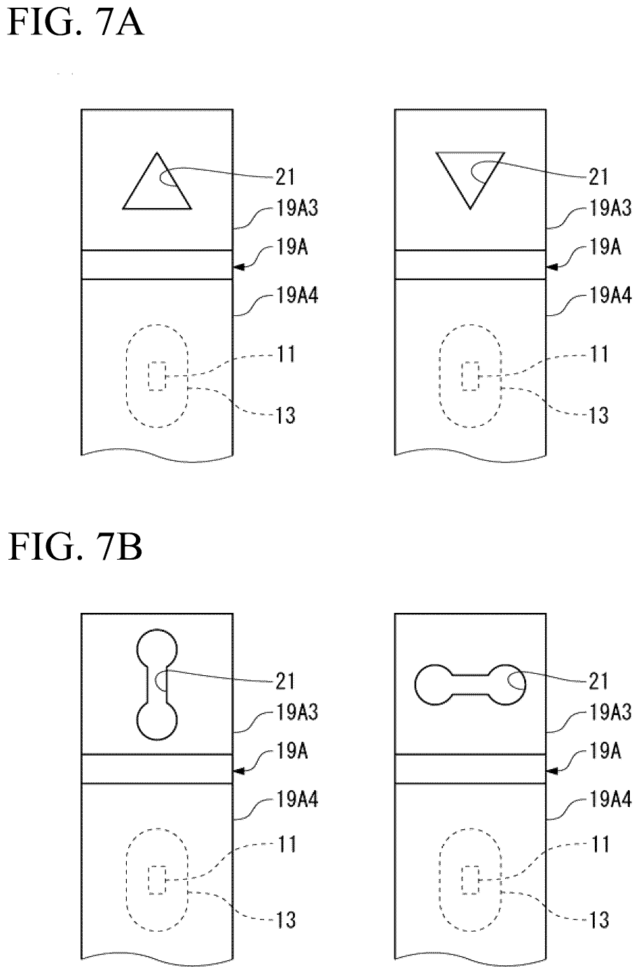

In FIGS. 1A, 1B to FIGS. 5A, 5B, the fixing hole 21 having a circular planar shape is exemplified. In contrast, FIGS. 6A, 6B and FIGS. 7A, 7B illustrate examples of the shape of the fixing hole 21 other than the circular shape. The shape of the fixing hole 21 according to the present invention is not limited to the circular shape exemplified above, and can be appropriately changed depending on the specifications such as the position of the fixing hole 21 and the dimension of the fastening tool.

In the present invention, the fixing hole 21 having an oval shape as illustrated in FIG. 6A, and the fixing hole 21 having a rectangular shape as illustrated in FIG. 6B is adoptable. The oval shape used herein is defined as a concept that includes an elliptical shape and a racetrack shape. The rectangular shape used herein is defined as a concept that includes a rhombic shape including a square shape, and a parallelogram shape including an oblong square shape. Further, in the present invention, the fixing hole 21 having a triangular shape as illustrated in FIG. 7A is adoptable, and the fixing hole 21 having an irregular shape as illustrated in FIG. 7B is adoptable.

The illustrations and descriptions have been given so far on the premise that the dimension in the thickness direction (T) of the fixing hole 21 is fixed; however, the dimension in the thickness direction (T) of the fixing hole 21 may be varied, for example, so as to be reduced from one surface side toward the other surface side.

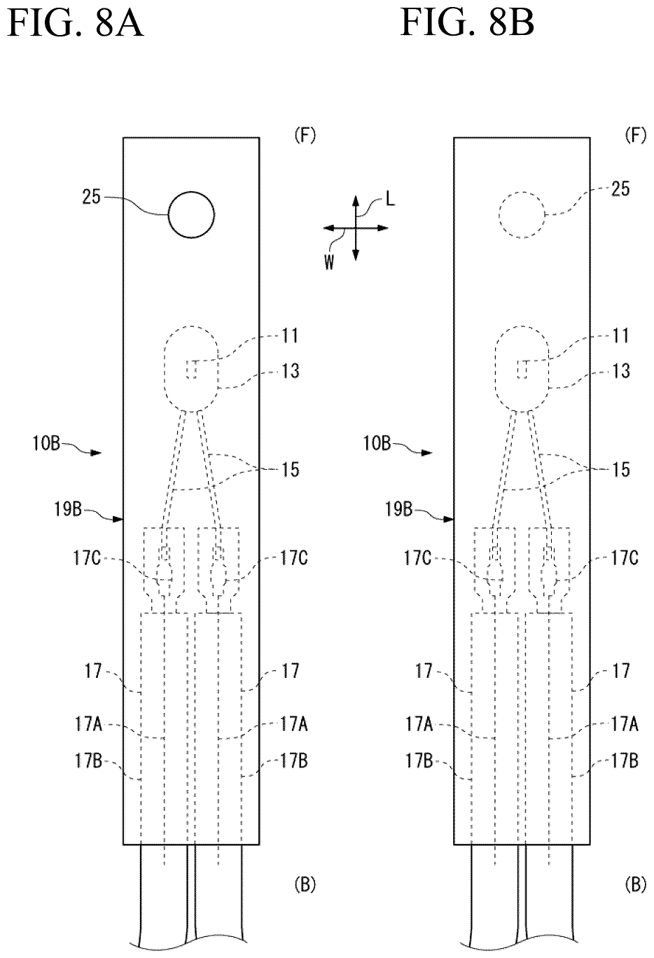

### [Second Embodiment: FIGS. 8A, 8B, FIGS. 9A, 9B, FIGS. 10A, 10B, and FIGS. 11A, 11B, 11C]

Next, as a temperature sensor 10B according to a second embodiment, for example, a case where a fixing protrusion 25 to be inserted into the retention hole 31 of the temperature measurement object 30 is provided as an example of the fixing element to the measurement object, is described. The fixing protrusion 25 is provided on a protector 19B directly covering the thermosensitive body 11 of the temperature sensor 10B. The temperature sensor 10B is described below with reference to FIGS. 8A, 8B to FIGS. 11A, 11B, 11C. In FIGS. 8A, 8B to FIGS. 11A, 11B, 11C, the components same as the components of the temperature sensor 10A described above are denoted by the same reference numerals, and descriptions of the components are omitted. In the following descriptions, the protector 19B will be focused on.

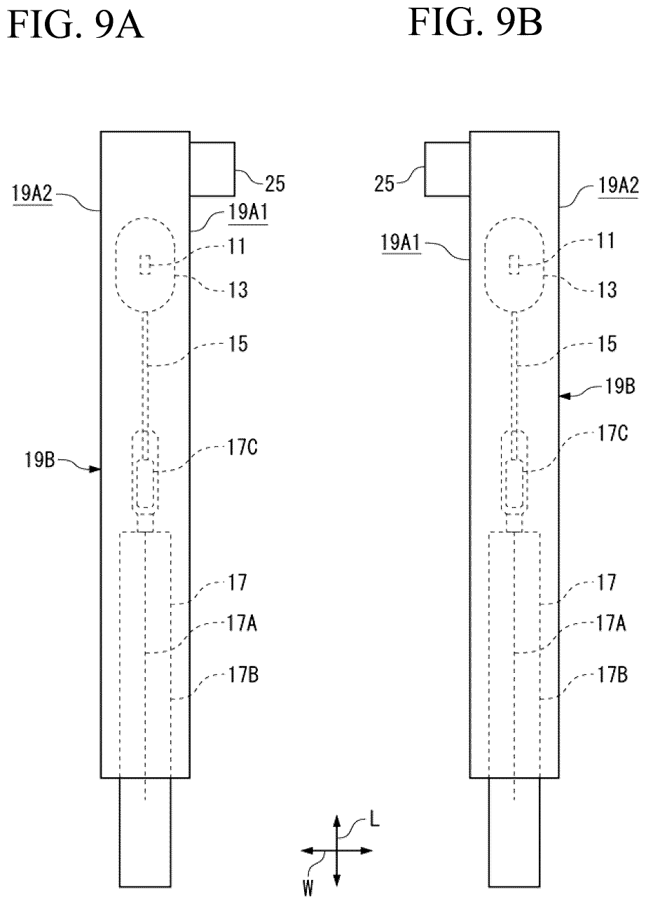

### [Protector 19B: FIGS. 8A, 8B and FIGS. 9A, 9B]

The protector 19B includes, ahead of the thermosensitive body 11 (i.e, closer to the front side (F) than the thermosensitive body 11), the fixing protrusion 25 that protrudes from the front surface 19A1 (or rear surface 19A2) in the thickness direction (T). The fixing protrusion 25 is an example of the fixing element according to the present invention. The fixing protrusion 25 illustrated in FIGS. 8A, 8B and FIGS. 9A, 9B has a circular cross-sectional shape. However, the cross-sectional shape of the fixing protrusion 25 according to the present invention is not limited to the circular shape.

Likewise the fixing hole 21 of the temperature sensor 10A as described above, the fixing protrusion 25 can adopt various shapes as long as the fixing protrusion 25 can achieve the object. The protector 19B including the fixing protrusion 25 is integrally formed by, for example, injection molding of the above-described resin material. In other words, individual working manhours to form the fixing protrusion 25 in the protector 19B are not required. Note that the protector 19B illustrated in FIGS. 8A, 8B and FIGS. 9A, 9B does not include the thin portion 19A3 that is provided in the temperature sensor 10A and has the constant dimension in the thickness direction (T); however, the fixing protrusion 25 may be provided on the thin portion 19A3.

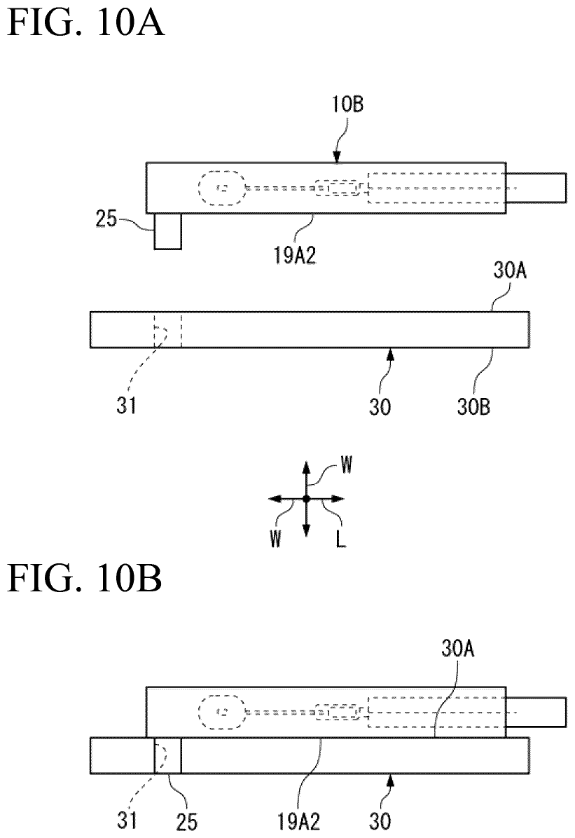

### [Procedure of Fixing Temperature Sensor 10B: FIGS. 10A, 10B]

Next, an example of a procedure of fixing the temperature sensor 10B to the temperature measurement object 30 is described with reference to FIGS. 10A, 10B. In the fixing procedure, the fixing protrusion 25 of the temperature sensor 10B is fixed to the temperature measurement object 30 as illustrated in FIG. 10A.

First, as illustrated in FIG. 10A, the fixing protrusion 25 of the protector 19A and the retention hole 31 provided in the temperature measurement object 30 are aligned. The alignment is performed in the longitudinal direction (L) and the width direction (W).

After the fixing protrusion 25 and the retention hole 31 are aligned, the fixing protrusion 25 is inserted into the retention hole 31 so as to penetrate through it, as illustrated in FIG. 10B. At this time, the fixing protrusion 25 is fixed to the protector 19 inside the retention hole 31 by optional means. For example, an outer diameter of the fixing protrusion 25 is set larger than an opening diameter of the retention hole 31, which makes it possible to press-fit and fix the fixing protrusion 25 into the retention hole 31. As the other means, the fixing protrusion 25 can be fixed to the retention hole 31 by an adhesive.

By the above-described procedure, the temperature sensor 10B can be brought into tight contact with the temperature measurement object 30. As illustrated in FIG. 10B, the supporting surface 30A of the temperature measurement object 30 on which the temperature sensor 10B is placed is flat, and the rear surface 19A2 of the protector 19B serving as a heat sensing surface of the temperature sensor 10B is also flat. Accordingly, the heat sensing surface of the temperature sensor 10B can be brought into tight contact with the supporting surface 30A of the temperature measurement object 30.

### [Effects by Temperature Sensor 10B]

In the temperature sensor 10B, the fixing protrusion 25 to fix the temperature sensor 10B to the temperature measurement object 30 is provided on the protector 19B. The protector 19B is provided to protect the thermosensitive body 11 and the like, and the temperature sensor 10B includes the fixing protrusion 25 on the protector 19B. Therefore, according to the temperature sensor 10B, a work of fabricating an individual member to provide the fixing protrusion 25 as the fixing element and attaching the member to the temperature sensor 10B can be eliminated. This makes it possible to reduce the working manhours required to fix the temperature sensor 10B to the temperature measurement object 30.

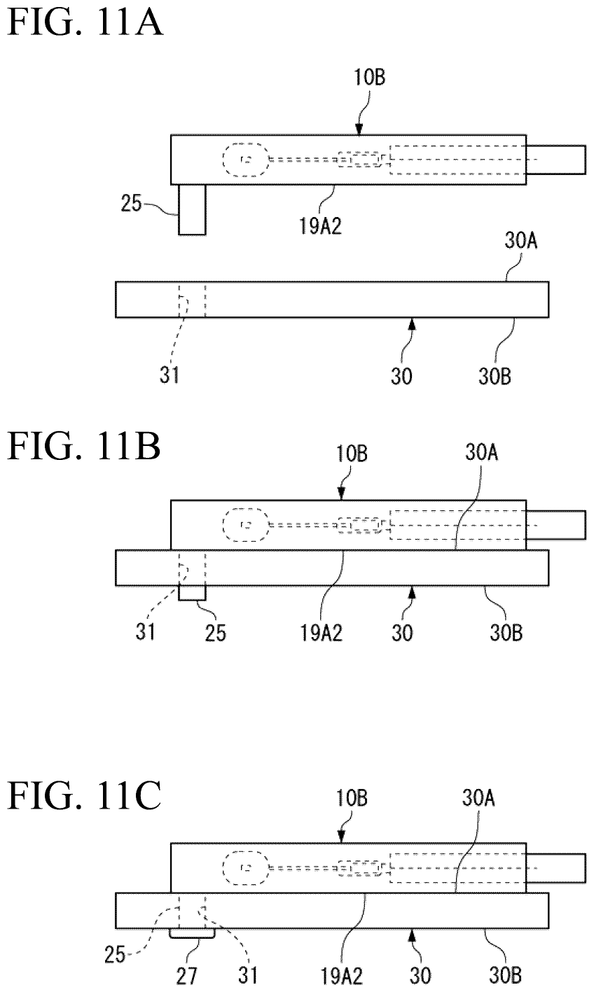

### [Modification of Second Embodiment: FIGS. 11A, 11B, and 11C]

Next, a modification of the temperature sensor 10B according to the second embodiment is described with reference to FIGS. 11A, 11B, and 11C.

In the temperature sensor 10B illustrated in FIGS. 11A, 11B, and 11C, a protruding dimension of the fixing protrusion 25 is set larger than the dimension in the thickness direction (T) of the temperature measurement object 30. Further, as illustrated in FIGS. 11A and 11B, the fixing protrusion 25 is inserted into the retention hole 31, and a front end of the fixing protrusion 25 is caused to protrude from the rear surface 30B of the temperature measurement object 30. Thereafter, a protruding portion from the rear surface 30B is softened by, for example, heating and is then squashed to form a locking end 27. By formation of the locking end 27, the temperature sensor 10B is fixed to the temperature measurement object 30.

Although the preferred embodiments of the present invention are described above, the configurations described in the afore-mentioned embodiments can be selected or may be replaced with other configurations without departing from the gist of the present invention.

The temperature sensor 10A according to the first embodiment includes the fixing hole 21, and the temperature sensor 10B according to the second embodiment includes the fixing protrusion 25; however, both of the fixing hole 21 and the fixing protrusion 25 can be provided in each of the protectors 19A and 19B. Providing both of the fixing hole 21 and the fixing protrusion 25 makes it possible to strengthen fixing strength between the temperature sensor and the temperature measurement object, and to accurately specify the relative positional relationship between the temperature sensor and the temperature measurement object as well.

In the first embodiment, the fixing hole 21 is provided so as to penetrate through the protector 19A from the front surface to the rear surface; however, the present invention is not limited thereto. For example, in a case where a fastening tool having a pointed front end like a wood screw can be used, a fixing hole that does not penetrate through the protector from the front surface to the rear surface and has a closed bottom part can be provided. In this case, the fastening tool having the pointed front end is screwed into the fixing hole to penetrate through the closed bottom part, thereby fixing the temperature sensor to the temperature measurement object.

In the second embodiment, the example in which the fixing protrusion 25 is press-fitted into the retention hole 31 when being inserted into the retention hole 31 is described; however, the present invention is not limited thereto. For example, after the fixing protrusion 25 is inserted into the retention hole 31 without applying pressure thereto, a fastening tool, for example, a wood screw having a pointed front end may be screwed into the fixing protrusion 25 inside the retention hole 31, to increase the diameter of the fixing protrusion 25 and to generate pressure in the fixing protrusion 25, thereby fixing the temperature sensor to the temperature measurement object 30.

### REFERENCE SIGNS LIST

10A, 10B Temperature sensor
11 Thermosensitive body
13 Protective layer
15 Extension wire
17 Lead wire
17A Core wire
17B Insulation covering
17C Pad
19A, 19B Protector
19A1 Front surface
19A2 Rear surface
19A3 Thin portion
19A4 Thick portion
21 Fixing hole
23 Fixing piece
25 Fixing protrusion
27 Locking end
30 Temperature measurement object
30A Supporting surface
31 Retention hole
33 Fastening tool
35 Bolt
35A Head portion
35B Screw portion
37 Nut

1. A temperature sensor, comprising:
a thermosensitive body;
a pair of electric wires electrically connected to the thermosensitive body;
a protector made of a resin and covering the thermosensitive body and a part of the pair of electric wires; and
a fixing element provided integrally with the protector and used for fixation to a temperature measurement object.

2. The temperature sensor according to claim 1, wherein the fixing element is provided in a free region off a sensor element retention area of the protector where the thermosensitive body and the electric wires are provided.

3. The temperature sensor according to claim 2, wherein the free region has a dimension in a thickness direction set less than a dimension in the thickness direction of the sensor element retention area.

4. The temperature sensor according to claim 1, wherein the fixing element is a fixing hole penetrating through the protector from a front surface to a rear surface.

5. The temperature sensor according to claim 4, wherein the temperature sensor is fixed to the temperature measurement object by a fastening tool inserted into the fixing hole.

6. The temperature sensor according to claim 1, wherein the fixing element is a fixing protrusion protruding from a surface of the protector.

7. The temperature sensor according to claim 6, wherein the temperature sensor is fixed to the temperature measurement object with the fixing protrusion being inserted into a retention hole provided in the temperature measurement object.

8. The temperature sensor according to claim 2, wherein the fixing element is a fixing hole penetrating through the protector from a front surface to a rear surface.

9. The temperature sensor according to claim 3, wherein the fixing element is a fixing hole penetrating through the protector from a front surface to a rear surface.

10. The temperature sensor according to 2, wherein the fixing element is a fixing protrusion protruding from a surface of the protector.

11. The temperature sensor according to 3, wherein the fixing element is a fixing protrusion protruding from a surface of the protector.

12. The temperature sensor according to 4, wherein the fixing element is a fixing protrusion protruding from a surface of the protector.

13. The temperature sensor according to claim 10, wherein the temperature sensor is fixed to the temperature measurement object with the fixing protrusion being inserted into a retention hole provided in the temperature measurement object.

14. The temperature sensor according to claim 11, wherein the temperature sensor is fixed to the temperature measurement object with the fixing protrusion being inserted into a retention hole provided in the temperature measurement object.

15. The temperature sensor according to claim 12, wherein the temperature sensor is fixed to the temperature measurement object with the fixing protrusion being inserted into a retention hole provided in the temperature measurement object.
